(19) United States
(12) Patent Application Publication
(10) Pub. No.: US 2010/0310109 A1
(43) Pub. Date: Dec. 9, 2010

(54) SUPPORT MEMBER FOR SPEAKER VIBRATING BODY AND SPEAKER DEVICE

(75) Inventors: Hiroyuki Dohi, Yamagata (JP); Tatsuya Suzuki, Yamagata (JP)

Correspondence Address: OSHA LIANG L.L.P., TWO HOUSTON CENTER, 909 FANNIN, SUITE 3500, HOUSTON, TX, 77010, US

(73) Assignees: PIONEER CORPORATION, Tokyo (JP); TOHOKU PIONEER CORPORATION, Yamagata (JP)

(21) Appl. No.: 12/676,836

(22) PCT Filed: Sep. 26, 2007
(86) PCT No.: PCT/JP2007/068655

§ 371 Date: Mar. 5, 2010

(51) Int. Cl. H04R 1/02

(52) U.S. Cl. 381/386

(57) ABSTRACT

A speaker device where the dip in the middle sound range is reduced, which provides reproduced sound of comparatively high quality, and provides reproduced sound of comparatively high sound pressure. In the speaker device, a support member for a speaker vibrator is adopted for an edge. The speaker device has a movable part (85) having bent parts, or more specifically, having a top bent part, an inner bent part, and an outer bent part. Because the movable part (85) is formed such that the top bent part is positioned closer to the radial center of the speaker device than the radial center between the inner bent part and the outer bent part, the edge (8) has comparatively high rigidity. Consequently, the dip in the middle sound range can be reduced by a simple structure without forming, for example, a damping agent layer and a resin layer on the support member for a speaker vibrator.

### FIELD OF THE INVENTION

The invention is related to a support member for a speaker vibrating body and a speaker device.

### BACKGROUND OF THE INVENTION

According to a speaker device including a cone-shaped diaphragm and an outer-magnet-type magnetic circuit, the diaphragm has the outer periphery vibratably supported by a frame through a support member such as an edge or a damper. According to the speaker device as constituted above, dip in response can occur in the midrange of a sound pressure-frequency characteristic due to a resonance or an unwanted vibration of the diaphragm and the support member when the speaker is driven.

A speaker device is known having an edge coated with a damping agent or an edge having a base member made of a paper and a resin layer formed on the base member with coating a polyol polyolefin resin (for example, see Japanese Laid-open Patent Publication 1993-244686).

### DISCLOSURE OF THE INVENTION

### Problems Solved by the Invention

However, according to the speaker device having the edge coated with a damping agent, an adhesive damping agent need be coated on the edge in the final manufacturing process. Further, according to the speaker device including the edge having the base member made of a paper and the resin layer coated on the base member, an applicable material is limited because that the base member of the edge is made of a paper. In addition, the speaker device is comparatively heavy due to the resin layer coated on the base member of the edge, and there is a case that it is difficult to reproduce a sound with a comparatively large sound pressure.

An object of the present invention is to solve the problem described above. The above-mentioned problems are examples of the objective of the present invention. In other words, it is the object of the present invention to reduce a dip in the midrange using a simple configuration without forming a damping agent layer or a resin layer on the support member for a speaker vibrating body, or to reproduce a sound with comparatively a high sound quality, or to reproduce a sound with a comparatively high sound pressure.

### Means for Solving the Problems

To achieve the objects as described above, the present invention includes at least the following constitutions according to the respective independent claims. According to one aspect of the present invention, a support member for a speaker vibrating body is disposed between the speaker vibrating body and a speaker frame, comprising a movable part including a top folding part, an inner folding part and an outer folding part, wherein the movable part includes a shape that the top folding part is arranged at a position in a center side as a reference of a middle point between the inner folding part and the outer folding part in a radial direction of the support member.

According to another aspect of the present invention, the support member for a speaker vibrating body is disposed between the speaker vibrating body and a speaker frame, the support member for the vibrating body including a movable part including a rising part, a falling part and a top folding part between the rising part and the falling part, wherein the angle of the rising part with reference to a radial direction is greater than the angle of the falling part to the radial direction.

Further, the speaker device according to the present invention includes the support member for a speaker vibrating body.

### BRIEF DESCRIPTION OF THE DRAWINGS

FIG. 1 is a sectional view of a speaker device 100 adopting a support member for a speaker vibrating body according to one embodiment of the present invention;

FIG. 2 is an enlarged sectional view around edge 8 of the speaker device 100 shown in FIG. 1;

FIG. 3 is a sectional view for illustrating the edge shown in FIG. 2: (A) is a sectional view of the edge and (B) is an enlarged view of the edge for illustrating folding parts of the edge;

FIG. 4 illustrates the movements of a general edge 8J, more specifically (A) is a sectional view of the edge 8J when it is not driven, (B) is a sectional view of the edge 8J when the diaphragm is displaced upward (acoustic wave emitting direction), (C) is a sectional view of the edge 8J when the diaphragm is not displaced, and (D) is a sectional view of the edge 81 when the diaphragm is displaced downward (opposite to the acoustic wave emitting direction);

FIG. 5 illustrates the movements of an edge 8 of the speaker device 100 according to one embodiment of the present invention, more specifically (A) is a sectional view of the edge 8 when it is not driven, (B) is a sectional view of the edge 8 when the diaphragm is displaced upward (acoustic wave emitting direction), (C) is a sectional view of the edge 8 when the diaphragm is not displaced, and (D) is a sectional view of the edge 8 when the diaphragm is displaced downward (opposite to the acoustic wave emitting direction);

FIG. 6 shows the results of computer simulations: (A) is a sectional view of a general edge J, (B) is a sectional view of an edge (support member) P according to one embodiment of the present invention, and (C) shows sound pressure level (SPL) frequency characteristics;

FIG. 7 (A) is a sectional view of edges A1 to A3 having angle-shaped peaks with different radii of curvature, and (B) shows sound pressure level (SPL) frequency characteristics of the edges shown in (A);

FIG. 8 (A) is a sectional view of edges B1 to B3 with angle-shaped movable parts having different rising angles, and (B) shows sound pressure level (SPL) frequency characteristics of the edges shown in (A);

FIG. 9 (A) is a sectional view of edges C1 to C3 wherein the rising angle AG1 of the inner movable part is different from the rising angle AG3 of the outer movable part, and (B) shows sound pressure level (SPL) frequency characteristics of the edges C1 to C3 shown in (A); and

FIG. 10 (A) is a sectional view of edges D1 to D3 with angle-shaped movable parts having different rising angles, and (B) shows sound pressure level (SPL) frequency characteristics of the edges shown in (A).

### BEST MODE OF THE INVENTION

According to one aspect of the embodiments of the present invention, a support member for a speaker vibrating body is disposed between the speaker vibrating body and a speaker frame, comprising a movable part including a top folding part, an inner folding part and an outer folding part, wherein the movable part includes a shape that the top folding part is arranged at a position in a center side as a reference of compared to a middle point between the inner folding part and the outer folding part in a radial direction.

Further, according to another aspect of the embodiments of the present invention, the speaker device includes the support member for the speaker vibrating body.

The speaker including the support member for the speaker vibrating body as constituted above includes the movable part including a shape that the top folding part is arranged at a position in a center side as a reference of the middle point between the inner folding part and the outer folding part in the radial direction. For example, the top folding part can have a comparatively large rigidity compared to a support member having a simple mountain-shaped cross-section in the middle point between the inner folding part and the outer folding part in the radial direction. Thus the speaker can reduce a resonance in a midrange (for example, approximately 300 Hz to 1 KHz) and an unwanted vibration when the speaker is driven, and the speaker can reduce a dip in the midrange of sound pressure frequency characteristic.

Further, according to one embodiment of the present invention, the support member for a speaker vibrating body includes a movable part including a rising part, a falling part and a top folding part between the rising part and the falling part. The angle between the rising part and the radial direction is large compared to the angle between the falling part and the radial direction. The speaker includes the support member for the speaker vibrating body as described above. The angle between the rising part of the movable part and the radial direction is large compared to the angle between the falling part and the radial direction. Thus, for example, the top folding part can have a comparatively great rigidity compared to the support member having a simple mountain-shaped cross-section in the middle point between the inner folding part and the outer folding part in the radial direction, and the speaker can reduce a resonance and an unwanted vibration in the midrange, and reduce a dip in the midrange of sound pressure frequency characteristic, when it is driven.

Hereinafter, the support member for a speaker vibrating body and the speaker device are described according to one embodiment of the present invention with reference to the drawings.

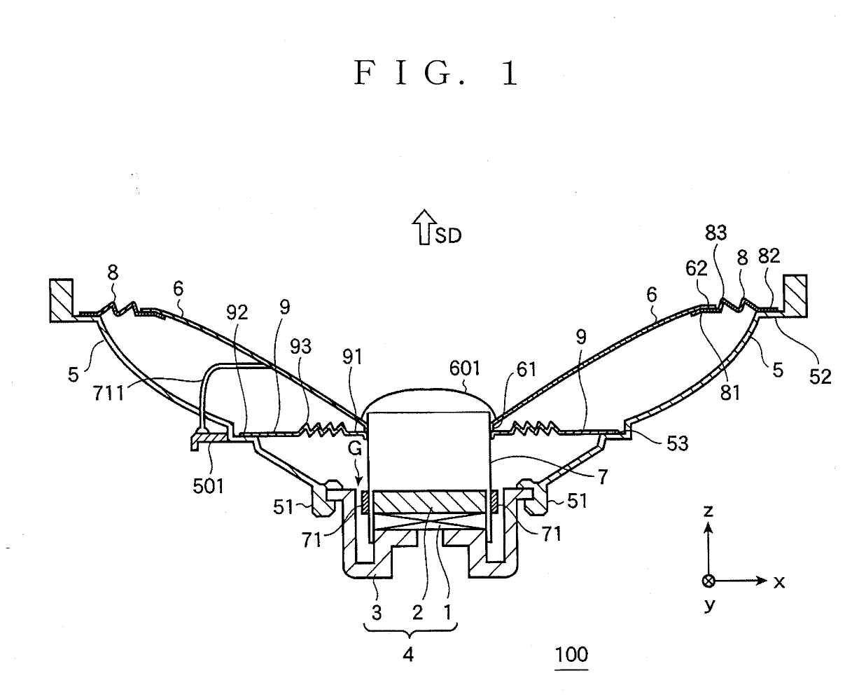

FIG. 1 is a sectional view of a speaker device 100 adopting a support member for a speaker vibrating body according to one embodiment of the present invention. As shown in FIG. 1, the speaker device 100 according to the embodiment includes a magnet 1, a plate 2, a yoke 3, a magnetic circuit 4, a speaker frame (frame) 5, a diaphragm 6, a voice coil bobbin 7, a voice coil 71, an edge 8, a damper 9, and a center cap 601. An inner-magnet type magnetic circuit having the magnet 1, plate 2, yoke 3 is adopted as the magnetic circuit 4 according to the embodiment, however other types, for example an outer-magnet type magnetic circuit may be adopted.

The edge 8 corresponds to a support member for a speaker vibrating body according to one embodiment of the present invention. The damper 9 corresponds to a support member for a speaker vibrating body according to one embodiment of the present invention. The diaphragm 6 and voice coil bobbin 7 correspond to a vibrating body according to one embodiment of the present invention. The speaker frame 5 corresponds to a speaker frame according to one embodiment of the present invention.

The magnet 1 may be a permanent magnet such as a neodymium-type magnet, a samarium-cobalt-type magnet, an alnico-type magnet, and a ferrite-type magnet. The magnet 1 is formed, for example, in a shape of a circular plate and is substantially formed in a similar size or a small size of outer diameter. The magnet is arranged on the yoke 3.

The plate 2 is formed, for example, in a shape of a circular plate and arranged on the magnet 1. The plate 2 is made of, for example a metal with a comparatively high magnetic permeability and a saturation magnetic flux density.

The yoke 3 is concave. The magnet 1 is arranged in the center portion of the yoke. Further, the yoke 3 is made of, for example a metal with a comparatively high magnetic permeability and a saturation magnetic flux density. Further, the outer periphery end of the yoke 3 is elongated to the height of the plate 2. The magnetic circuit 4 includes the magnet 1, plate 2, and yoke 3. The magnetic circuit 4 has a magnetic gap (G) between the outer periphery end of the yoke 3 and the plate 2. The voice coil 71 wound around the voice coil bobbin 7 is vibratably arranged in the magnetic gap (G).

The frame 5 is formed substantially in a cone shape, having an inner periphery end 51 attached to the end of the yoke 3 and an outer periphery end 52 attached to the end of the edge 8. Further, a step part 53 on which the outer periphery end of the damper is attached, is formed substantially at a center portion between the inner periphery end 51 and the outer periphery end 52. The frame 5 is made of a high-polymer material such as a resin or a metal.

The diaphragm 6 has an inner periphery end 61 fixed to the voice coil bobbin 7 with an adhesive or the like and an outer periphery end 62 vibratably supported by the frame 5 via the edge 8. Various forms such as a dome, a cone, a plate, or a horn can be adopted for the form of the diaphragm 6. The diaphragm 6 according to this embodiment is formed in a cone shape as shown in FIG. 1. The diaphragm 6 is made of, for example a metal material, a polymer material such as a thermoplastic resin and a thermoset resin, and a member formed by fibers such as a paper. Metals such as aluminum, titanium, duralumin, beryllium, and a magnesium alloy can be adopted. A thermoplastic material such as a polypropylene resin, polyethylene, polystyrene, polyethyleneterephthalate, and polymethylmethacrylate can be adopted. A thermoset material such as a polypropylene resin, polyethylene, polystyrene, polyethyleneterephthalate, and polymethylmethacrylate can be adopted. Further, as shown in FIG. 1, a center cap 601 is arranged at the center portion of the diaphragm 6 to prevent dust.

The voice coil bobbin 7 is formed, for example, cylindrically as shown in FIG. 1, and arranged such that the direction of vibration (z-axis direction) is arranged in line with the center axis of the speaker. The voice coil 71, as described above, is wound around the voice coil bobbin 7. The voice coil 71 is electrically connected to a terminal 501 formed at the frame 5 via a conductive line 711.

The damper 9 has an inner periphery part 91 fixed to the voice coil bobbin 7 with an adhesive, or the like and an outer periphery part 92 fixed to the frame 5 with an adhesive or the like and a movable part 93 having its cross-sectional shape formed in a substantially corrugated shape is formed near the center portion between the inner periphery part 91 and the outer periphery part 92 in a radial direction. The damper 9 vibratably supports the voice coil bobbin 7 in a vertical direction (Z-axis direction, acoustic wave emitting direction) to prevent the voice coil bobbin 7 from contacting in the magnetic gap (G) of the magnetic circuit 4, and keeps the voice coil 71 in a predetermined position when the voice coil is still. The damper 9 according to this embodiment can have a cross-sectional shape in a radial direction formed in a corrugated shape, or have a similar form or material as the edge according to the present invention as described later.

### [Edge 8]

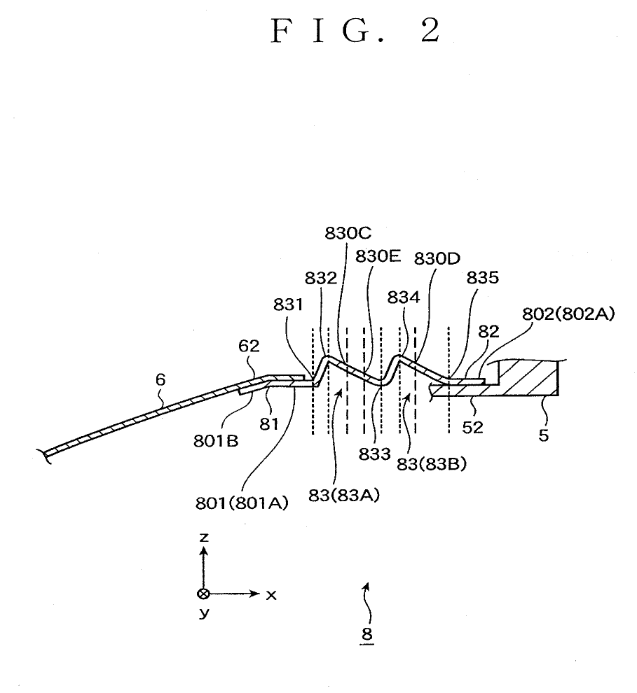

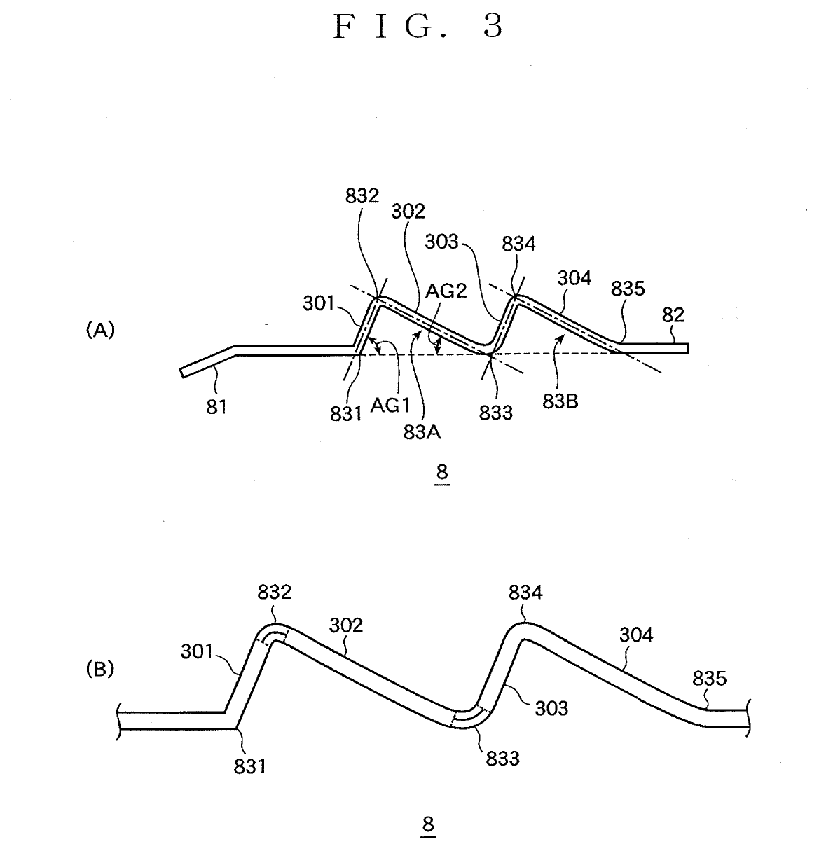

FIG. 2 is an enlarged sectional view around edge 8 of the speaker device 100 shown in FIG. 1. FIG. 3 is a sectional view for illustrating the edge shown in FIG. 2. Specifically, FIG. 3(A) is a sectional view of the edge and FIG. 3(B) is an enlarged view of the edge for illustrating folding parts of the edge. The edge 8 is described in detail with reference to FIG. 2, FIG. 3(A) and FIG. 3(B).

The edge 8 is arranged between an outer periphery end 62 of the diaphragm 6 and an outer periphery end 52 of the frame 5 and formed, for example, in a ring shape. A well-known material such as a paper, a rubber, a resin, a cloth and a leather can be adopted as a material for the edge 8. The edge 8 vibratably supports the diaphragm 6 flexibly following the displacement of the diaphragm 6. The edge 8 has a movable part 83 with a mountain-shaped cross-sectional shape formed between an inner periphery end 81 and an outer periphery end 82 of the edge 8. In addition, the edge 8 has a function of an acoustic terminal of the diaphragm 6.

The edge 8, as shown in FIG. 2, includes a diaphragm attaching part 801, a frame attaching part 802, and the movable parts 83. The diaphragm attaching part 801 is formed at the inner periphery end 81 of the edge 8 and fixed to the outer periphery end 62 of the diaphragm 6 with adhesive. The diaphragm attaching part 801 has a flat part 801A formed in the center side of the movable parts 83 in the radial direction. The flat part 801 A has a slope 801B at the inner periphery side corresponding to the contour of the diaphragm 6.

The frame attaching part 802 is formed at the outer periphery end 82 of the edge 8 and fixed to the outer periphery end 52 of the frame 5 with adhesive. The frame attaching part 802 has a flat part 802A in the outside of the movable parts 83 in the radial direction.

The movable part 83 is formed between the diaphragm attaching part 801 and the frame attaching part 802. The movable parts 83 according to the embodiment have a mountain-shaped cross-section in a radial direction and protruding in an acoustic wave emitting direction (SD) (foreside) as shown in FIGS. 1 and 2. Further, the movable part 83 includes a top folding part, an inner folding part and an outer folding part. The movable part is formed such that the top folding part is arranged in the center side in the radial direction compared to the middle point in a radial direction between the inner folding part and the outer folding part. As shown in FIG. 2, the edge 8 according to the embodiment includes a plurality of the movable parts 83, more specifically the movable part 83A and 83B as two movable parts. The edge 8 includes folding parts 831 to 835 as a plurality of the folding parts. The respective folding parts 831 to 835 have cross-sections in the radial direction formed in a curved line.

More specifically, as shown in FIG. 2, a folding part 832 corresponds to the top folding part of the movable part 83A, a folding part 831 corresponds to the inner folding part of the movable part 83A, and a folding part 833 corresponds to the outer folding part of the movable part 83A. The folding part 834 corresponds to the top folding part of the movable part 83B, a folding part 833 corresponds to the inner folding part of the movable part 83B, and a folding part 835 corresponds to the outer folding part of the movable part 83B.

Therefore, the top folding part 832 is formed in the center side in the radial direction compared to the middle point 830C between the folding part 831 and the folding part 833 in the radial direction. The top folding part 834 is formed in the center side in the radial direction compared to the radial middle point 830D between the folding part 833 and the outer folding part 835. Further, the folding part 833 corresponds to a middle folding part formed between the top folding part 832 and the top folding part 834 of the respective movable parts 83A and 83B adjacent to each other. The folding part 833 corresponds to the middle folding part formed at the outside of the middle point 830E between the top folding parts 832 and 834 of the respective movable parts 83A and 83B adjacent to each other in the radial direction.

Further, as shown in FIG. 2, in the edge 8 according to the preferred embodiment, the folding parts 831,833 and 835 are formed to lie in substantially the same plane. Further the edge 8 according to this embodiment is formed such that respective distances to the folding parts 832 and 834 are substantially the same in an orthogonal direction (acoustic wave emitting direction SD) from a reference plane, the reference plane is a plane on which the folding parts 831,833 and 835 are arranged. Further, the height (H) of the top folding parts 832 and 834 are substantially the same as the radial distance between the folding parts 831 and 833 or less (approximately 0.7 to 0.9 times as much).

The movable parts 83 include a rising part formed between the top folding part and the inner folding part and a falling part formed between the top folding part and the outer folding part. Specifically, as shown in FIG. 3 a rising part 301 is formed between the folding part 831 and the folding part 832, and a falling part 302 is formed between the folding part 832 and the folding part 833. A rising part 303 is formed between the folding part 833 and the folding part 834, and a falling part 304 is formed between the folding part 834 and the folding part 835. The rising parts 301 and 303, and the falling parts 302 and 304 have cross-sectional shapes formed in a straight line.

As shown in FIG. 3(A), the movable part 83A has a radial cross-sectional shape formed such that the angle (AG1) between the rising part 301 and a radial direction (horizontal direction) is greater than the angle (AG2) between the falling part 302 and the radial direction. The movable part 83B has a radial cross-sectional shape formed such that the angle between the rising part 303 and the radial direction (horizontal direction) is greater than the angle between the falling part 304 and the radial direction.

As described later, the angle between the rising part and the radial direction is preferably arranged approximately 60 degrees to 85 degrees. When the angle is as noted above, the edge 8 can have a comparatively high rigidity, and a dip in the sound pressure frequency characteristic can be reduced.

As shown in FIG. 3 (B), the edge 8 has the top folding part and the middle folding part with respectively different lengths along a surface, or along the middle point between both surfaces. For example, the lengths along the middle point between both surfaces of the folding parts 832 and 833 are shown in heavy lines in FIG. 3 (B). The lengths along the middle point between both surfaces of the folding part 834 (not shown) can be shown in the similar fashion. Further, as shown in FIG. 3(B), a radius of curvature of the folding part 833 is larger than those of the folding parts 832 and 834. Therefore, the length of the folding part 833 along the surface or along the middle point of both surfaces is longer than those of the folding parts 832 and 834. In the edge 8 as constituted above, the folding parts 832 and 834 has the small radius of curvature compared to that of the middle folding part 833, and is more rigid and less deformable.

Hereinafter, the movements of the edge 8 as constituted above are described according to a preferred embodiment of the present invention in comparison with the movements of a general edge 8J with a simply symmetric mountain-shaped cross-section in the radial direction.

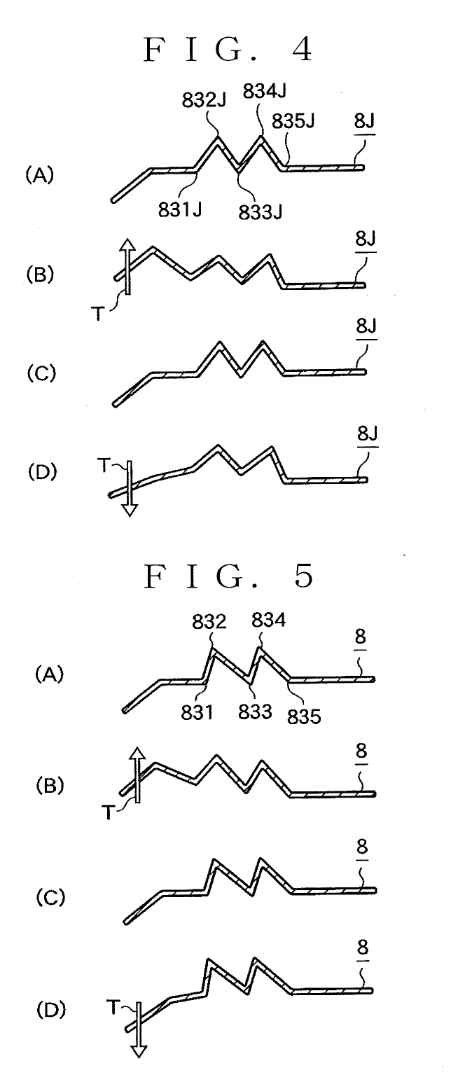

FIG. 4 illustrates the movements of a general edge 8J, more specifically FIG. 4(A) is a sectional view of the edge 8J when it is not driven, FIG. 4 (B) is a sectional view of the edge 8J when the diaphragm is displaced upward (acoustic wave emitting direction), FIG. 4 (C) is a sectional view of the edge 8J when the diaphragm is not displaced, and FIG. 4 (D) is a sectional view of the edge 8J when the diaphragm is displaced downward (opposite to acoustic wave emitting direction).

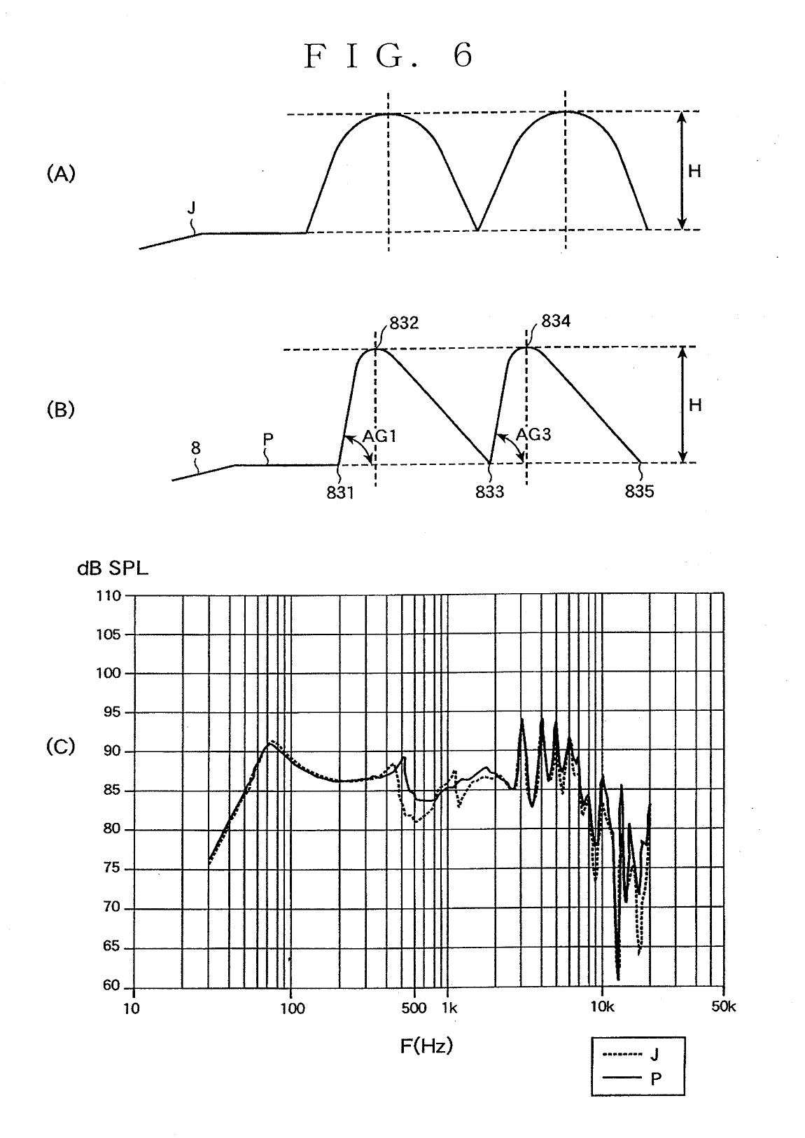

FIG. 5 illustrates the movements of the edge 8 of the speaker device 100 according to a preferred embodiment of the present invention, more specifically FIG. 5 (A) is a sectional view of the edge 8 when it is not driven, FIG. 5 (B) is a sectional view of the edge 8 when the diaphragm is displaced upward (acoustic wave emitting direction), FIG. 5 (C) is a sectional view of the edge 8 when the diaphragm is not displaced, and FIG. 5 (D) is a sectional view of the edge 8 when the diaphragm is displaced downward (opposite to the acoustic wave emitting direction).

In the general edge 8J, as shown in FIGS. 4(A) to 4(D), the folding angles especially of the folding parts 831J and 832J are changed by a driving force T larger than other folding parts depending on a displacement of the diaphragm in a driving direction (vertically in the drawings), for example when the speaker is driven. Specifically, the folding angles especially of the folding parts 831J and 832J when the speaker is driven are changed comparatively largely with reference to the time when the speaker is not driven. At this moment a resonance or an unwanted vibration occurs near the folding parts 831J and 832J, and a comparatively large dip occurs in the midrange of the sound pressure frequency characteristic.

As shown in FIGS. 5(A) to 5(D), in the edge 8 according to the present invention, the folding angle of the folding part 831 is approximately 60 to 85 degrees, and the top folding part 832 of the mountain-shaped movable part 83 is formed in the center side in the radial center compared to the radial middle point between the folding parts 831 and 833, thus the folding part 831 can have a comparatively high rigidity. Therefore, even if the diaphragm is displaced in the vibration direction (vertically in the drawings) when the speaker is driven, the change amount of the folding angle of the folding part 831 is comparatively small, thus substantially the same folding angle is maintained. Further, the edge 8 according to the embodiment of the present invention can reduce a resonance and an unwanted vibration, and reducing a dip in the midrange of the sound pressure frequency characteristic compared to the general edge 8J.

Further, the change amount of the folding angle of the folding part 832 is also comparatively small in the folding angle substantially as well as the folding part 831 described above. Further, the change amount of the folding angle of the folding part 834 is also comparatively small in the folding angle substantially as well as the folding part 832 described above. Thus, the edge 8 can reduce a resonance and an unwanted vibration, thus reducing a dip in the midrange of the sound pressure frequency characteristic compared to the general edge 8J.

### [Simulation]

The inventors confirmed an effect of the support member for the speaker vibrating body according to the embodiment of the present invention by comparing the sound pressure frequency characteristics by computer calculations (simulations) with regard to the edge 8 according to the embodiment and the general angle-shaped edge J. Hereinafter, described are the sound pressure frequency characteristics with reference to the drawings.

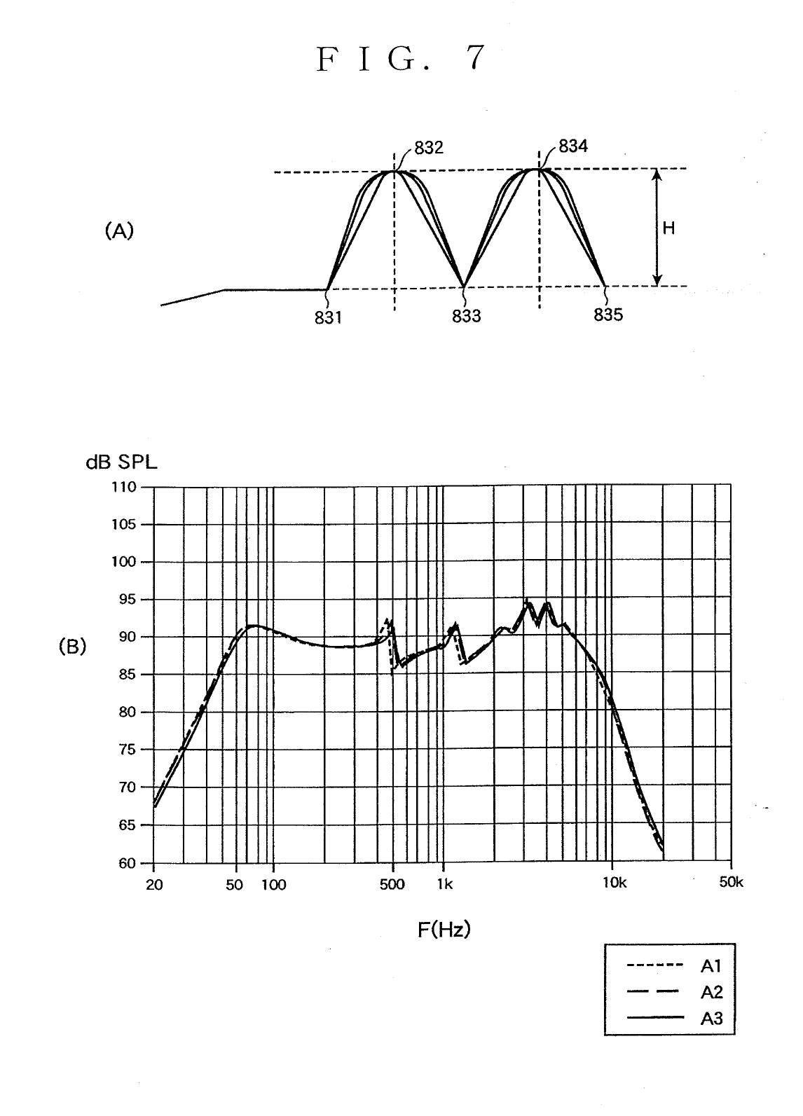

FIG. 6 shows the results of computer simulation:

FIG. 6(A) is a sectional view of the general edge J, FIG. 6 (B) is a sectional view of the edge (support member) P according to one embodiment of the present invention, and FIG. 6 (C) shows frequency characteristics of Sound Pressure Level (SPL). In FIG. 6(C), the horizontal axis represents frequency (F) (Hz), and the vertical axis represents Sound Pressure Level (dBSPL).

As shown in FIG. 6(A), the general edge J has a radial cross-sectional shape, the radial cross-sectional shape has two mountain-shape and a top portion arranged in the middle point of the mountain-shape. The height (H) of the top portion is set, for example, at 3.0 mm. Whereas, the edge 8(P) according to the present invention has the top folding part 832 located closer to the radial center than the radial middle point between the folding parts 831 and 833 and the top folding part 834 located closer to the radial center than the radial middle point between the folding parts 833 and 835 as shown in FIG. 6(B). Further, the angles AG1 and AG3 are set at 80 degrees. The heights (H) of the top folding parts 832 and 833 are set at 3.0 mm, similar as the edge J. The radii of curvature of the top folding parts 832 and 834 are set at 0.5 mm. As a result of the simulation, it has been found that the speaker device including the edge 8(P) according to the present invention reduces a dip in the midrange (approximately 300 Hz to 1 kHz) of the sound pressure frequency characteristic compared to the speaker device including the general edge 1, as shown in FIG. 6(C). Further, it has also been found that the speaker device including the edge 8(P) reduces a dip in the midrange and reproduces a sound with comparatively high sound quality.

### First Comparative Example

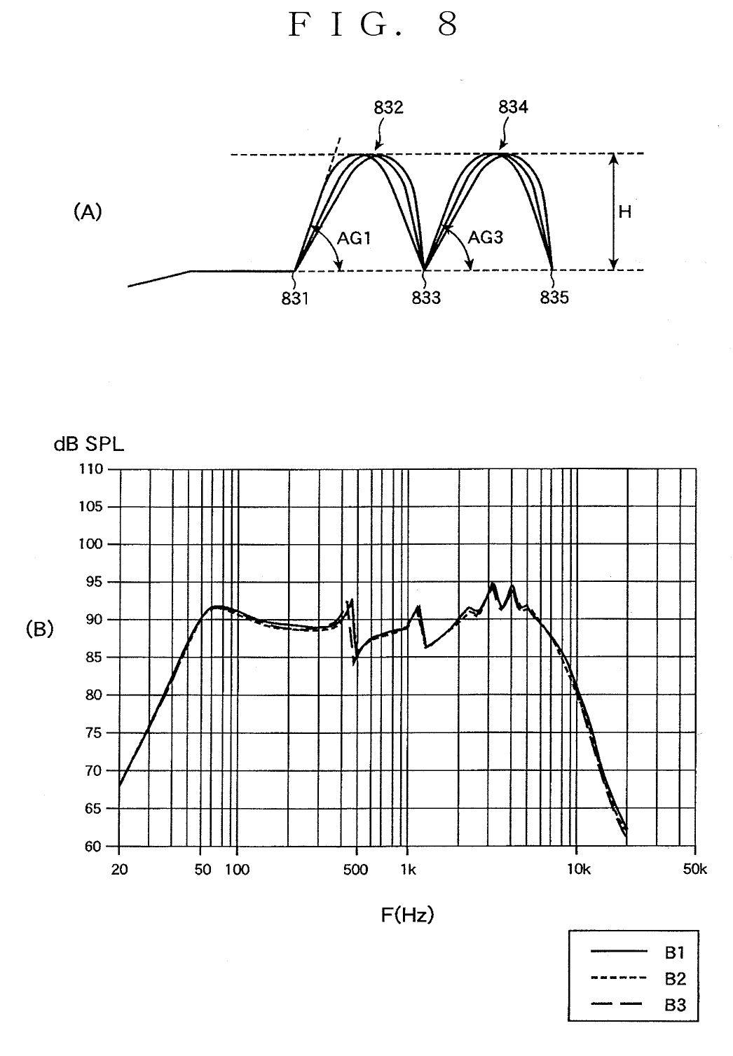

Hereinafter described are the sound pressure frequency characteristics of the speaker devices including edges having top portions of simple mountain-shapes, radii of curvature of which are different, as a comparative example. FIG. 7 (A) is a sectional view of edges A1 to A3 having mountain-shaped top portions with different radii of curvature, and (B) shows sound pressure frequency characteristics corresponding to the edges shown in 7 (A).

An edge A1 includes an inner movable part having a top portion with 3.0 mm in height and a top folding part 832 with 1.25 mm in the radius of curvature, and an outer movable part having a top portion with 3.0 mm in height and atop folding part 834 with 1.25 mm in the radius of curvature. An edge A2 includes an inner movable part having a top portion with 3.0 mm in height and a top folding part 832 with 1.0 mm in the radius of curvature, and an outer movable part having a top portion with 3.0 mm in height and a top folding part 834 with 1.0 mm in the radius of curvature. An edge A3 includes an inner movable part having a top portion with 3.0 mm in height and a top folding part 832 with 0.75 mm in the radius of curvature, and an outer movable part having a top portion with 3.0 mm in height and a top folding part 834 with 0.75 mm in the radius of curvature. The edges A1 to A3 have radial cross-sectional shapes such that top folding parts are arranged at the middle points of mountain-shapes.

As shown in FIG. 7(B), the smaller the radius of curvature for the top portion of the simple mountain-shaped cross-section, the more the dip in the midrange is reduced. However, as shown in FIG. 6(C) and FIG. 7(B), the speaker device including the edges A1 to A3 has a large dip in the midrange compared to the speaker device including the edge 8 (P) according to the embodiments of the present invention.

### Second Comparative Example

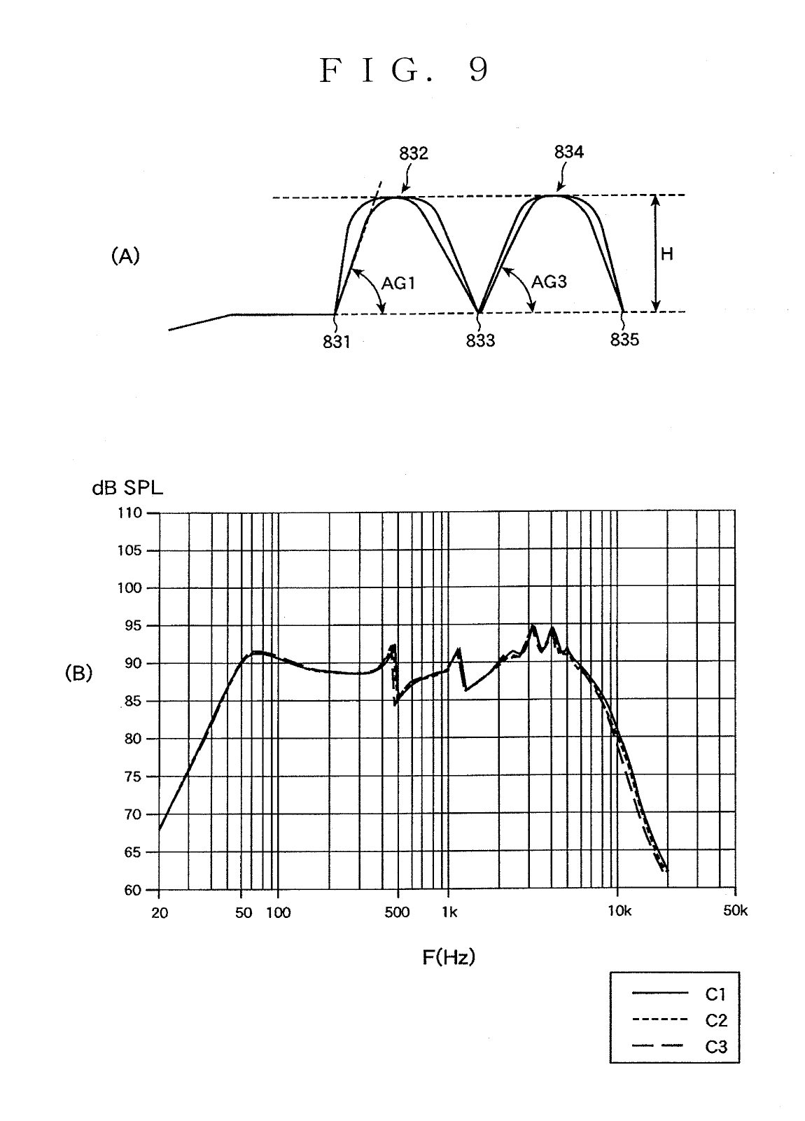

Hereinafter described are the sound pressure frequency characteristics of the speaker devices including edges B1 to B3 as a comparative example. The angles AG1 and AG3 of folding parts 831 and 833 are comparatively small and top folding parts 832 and 834 are located radially in the outside of the midpoints of the mountain-shape. FIG. 8 (A) is a cross-sectional view of edges B1 to B3 with angle-shaped movable parts having different rising angles, and FIG. 8(B) shows sound pressure frequency characteristics of the edges shown in FIG. 8(A).

In the edge B1, an angle (AG1) between the folding part 831 of an inner movable part and the radial direction is 68 degrees, while an angle (AG3) between the folding part 833 of an outer movable part and the radial direction is 68 degrees. In the edge B2, the angle (AG1) is 60 degrees and the angle (AG3) is 60 degrees. In the edge B3, the angle (AG1) is 55 degrees and the angle (AG3) is 55 degrees. Further, the edges B1 to B3 have movable parts with 3.0 mm in height (H) and with 1.25 mm in radius of curvature. The edge B1 is similar to the edge A1.

As shown in FIG. 8(B), in the speaker device including the edges B1 to B3 having the top folding parts, the top folding parts are located radially in the outside of the midpoints of the mountain-shape, the larger the angles AG1 and AG3, the more reduced is the dip in the midrange. However, as shown in FIG. 6(C) and FIG. 8(B), the speaker device including the edges B1 to B3 has a large dip in the midrange compared to the speaker device adopting the edge 8 (P) according to the embodiments of the present invention.

### Third Comparative Example

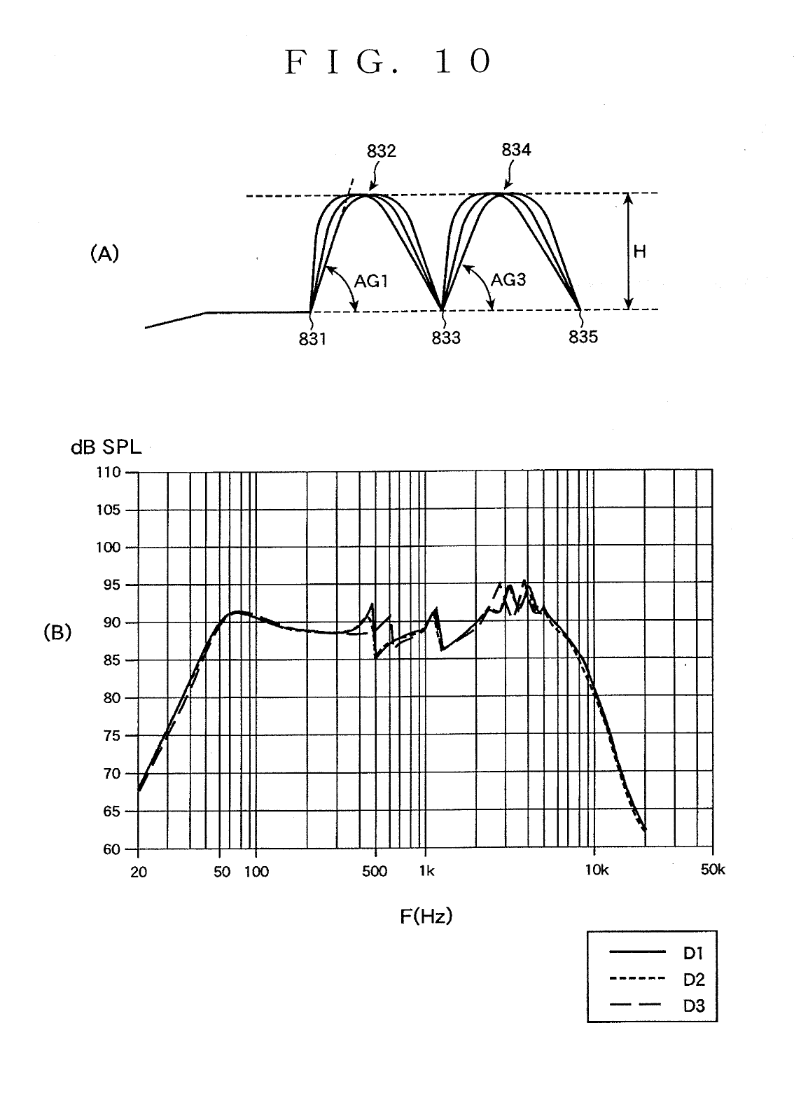

Hereinafter described are the sound pressure frequency characteristics of the speaker devices including edges C1 to C3 having an inner movable part and an outer movable part as a comparative example, the rising angle (AG1) of the inner movable part and the rising angle (AG3) of the outer movable part are different from each other. FIG. 9 (A) is a cross-sectional view of the edges C1 to C3, the rising angle (AG1) of the inner movable part is different from the rising angle (AG3) of the outer movable part, and FIG. 9(B) shows sound pressure frequency characteristics corresponding to the edges C1 to C3 shown in (A).

In the edge C1, an angle (AG1) between the folding part 831 of the inner movable part and the radial direction is 68 degrees, while an angle (AG3) between the folding part 833 of the outer movable part and the radial direction is 68 degrees. In the edge C2, the angle (AG1) is 80 degrees and the angle (AG3) is 68 degrees. In the edge C3, the angle (AG1) is 88 degrees and the angle (AG3) is 60 degrees. Further, the edges C1 to C3 have movable parts with 3.0 mm in height (H) and with 1.25 mm in radius of curvature. The edge C1 is similar to the edge A1.

As shown in FIG. 6(C) and FIG. 9(B), the speaker devices including the edges C1 to C3 having the inner movable part and the outer movable part, the rising angle (AG1) of the inner movable part and the rising angle (AG3) of the outer movable part are different from each other, has a large dip in the midrange compared to the speaker device including the edge 8 (P) according to the embodiments of the present invention.

### Modified Example According to the Embodiment of the Present Invention

Hereinafter described are the sound pressure frequency characteristics of the speaker devices including edges D1 to D3 having the folding parts 831 and 833 as a modified example according to the embodiments of the present invention, the rising angle AG1 of the folding part 831 and the rising angle AG3 of the folding part 833 are different from each other. The top folding parts of the edges D2 and D3 are located radially in the inside of the middle points of the mountain-shapes. FIG. 10 (A) is a cross-sectional view of edges D1 to D3 with mountain-shaped movable parts having different rising angles, and FIG. 10 (B) shows sound pressure frequency characteristics corresponding to the edges shown in FIG. 10 (A).

In the edge D1, an angle (AG1) between the folding part 831 of an inner movable part and the radial direction is 68 degrees, while an angle (AG3) between the folding part 833 of an outer movable part and the radial direction is 68 degrees. In the edge D2, the angle (AG1) is 75 degrees and the angle (AG3) is 75 degrees. In the edge D3, the angle (AG1) is 85 degrees and the angle (AG3) is 85 degrees. Further, the edges D1 to D3 have movable parts with 3.0 mm in height (H) and with 1.25 mm in radius of curvature. The edge D1 is similar to the edge A1. As shown in FIG. 10(B), the larger the angles AG1 and AG3 i.e. the closer to a radial center the top folding parts are located, the more reduced is a dip in the midrange. Especially, comparatively large effects can be seen in the frequency band of 500 to 600 Hz.

Further, as shown in FIG. 6 (C) to FIG. 10 (B), if the movable part of the edge is formed such that the top folding part is located closer to the radial center than the radial middle point between the inner folding part and the outer folding part, the dip in the midrange is reduced and the sound is reproduced with high sound quality. Further, as shown in FIG. 6 (C) to FIG. 10 (B), specifically when the angle between the radial direction and the rising part is about 60 degrees to about 85 degrees, the effects according to the embodiments of the present invention are comparatively large. Especially, when the angles (AG1) and (AG2) are 75 to 80 degrees, the effects according to the embodiments of the present invention are comparatively large.

As described above, the speaker device including as the edge the support member for the speaker vibrating body according to the embodiments of the present invention, includes the movable parts 85 having a plurality of the folding parts, more specifically, the top folding part, the inner folding part and the outer folding part, where the movable part 85 is formed such that the top folding part is located in the center side in the radial center of the support member compared to the radial middle point between the inner folding part and the outer folding part, the edge 8 has the comparatively high rigidity and the dip in the midrange can be reduced with a simple structure, for example without forming the damping agent layer or the resin layer on the support member for the speaker vibrating body. The speaker device according to the embodiments of the present invention including the support member as constituted above, the sound with comparatively high sound quality can be reproduced.

The invention is not limited to the embodiments described above. The combinations of the embodiments described above are available. In the embodiments described above, the speaker device according to the invention is described as the speaker device having an outer-magnet-type magnetic circuit, however the speaker device is not limited to the embodiments. The speaker device according to the present invention can include an inner-magnet-type magnetic circuit. Further, the diaphragm is not limited to the cone-shaped diaphragm. Various shapes such as a dome-shape and a flat-plate shape can be adopted. Further the edge 8 may be formed, for example in a convex or concave shape in an acoustic wave emitting direction (SD). Further the speaker device or the support member may be in a circular or in a ring shape viewed from the acoustic emitting side. Any shapes including, for example, rectangular, multangular and elliptical shapes can be applied to form the speaker device or the support member. The support member for a speaker vibrating body according to the present invention can be used not only for the edge but for the damper as described above. Further, it is possible to use the support member for the speaker vibrating body according to the present invention as edge while the damper is formed in a well-known shape, or alternatively to use the support member for the speaker vibrating body according to the present invention as the damper and the edge formed in a well-known shape. Further, although the edge 8 is described as a free edge that is formed in a separate member from the diaphragm in the embodiments described above, it is not limited to the embodiments. For example, a fixed edge in which an edge is formed integrally with the diaphragm 6 can be used as the support member for the speaker vibrating body according to the present invention.

Further, although the edge 8 includes two movable parts 83A and 83B in the embodiments described above, it is not limited to the embodiments. For example, the edge 8 can include a single movable part, or three or more movable parts.

1. A support member for a speaker vibrating body, disposed between the speaker vibrating body and a speaker frame, comprising:
a movable part including a top folding part, an inner folding part and an outer folding part, wherein
the movable part includes a shape that the top folding part is arranged at a position in a center side as a reference of a middle point between the inner folding part and the outer folding part in a radial direction.

2. The support member for the speaker vibrating body according to claim 1, comprising
a plurality of the movable parts.

3. The support member for the speaker vibrating body according to claim 1, wherein
the folding part of the movable part has a cross-sectional shape formed in a curved line.

4. The support member for the speaker vibrating body according to claim 1, wherein
the movable part includes a rising part and a falling part, wherein
the rising part is formed between the top folding part and the inner folding part, and
the falling part is formed between the top folding part and the outer folding part.

5. The support member for the speaker vibrating body according to claim 1, wherein
the movable part includes a plurality of the movable parts and a middle folding part formed between the top folding parts of the movable parts, wherein
a length of the top folding part is different from a length of the middle folding part along a surface or middle points between both the surfaces.

6. The support member for the speaker vibrating body according to claim 5, wherein
the middle folding part has a cross-sectional shape formed in a curved line.

7. The support member for the speaker vibrating body according to claim 1, comprising:
a plurality of the movable parts, wherein
a middle folding part is formed between adjacent movable parts, wherein
the middle folding part is arranged outward in the radial direction as a reference of a middle point between the top folding parts of adjacent movable parts.

8. The support member for the speaker vibrating body according to claim 1, comprising:
a flat part provided in a center side or outward in a radial direction of the movable part.

9. The support member for the speaker vibrating body according to claim 1, comprising:
a plurality of the movable parts, wherein
heights of the movable parts are substantially same.

10. The support member for the speaker vibrating body according to claim 1, wherein
the movable part includes a rising part formed between the top folding part and the inner folding part, wherein
an angle between the rising part and the radial direction is substantially from 60 degrees to 85 degrees.

11. The support member for the speaker vibrating body according to claim 4, wherein
the rising part or the falling part has a cross-sectional shape formed in a straight line.

12. A support member for a speaker vibrating body, disposed between the speaker vibrating body and a speaker frame, comprising:
a movable part including a rising part, a falling part and a top folding part provided between the rising part and the falling part, wherein
an angle between the rising part and a radial direction is greater than an angle between the falling part and the radial direction.

13. A speaker device comprising the support member for the speaker vibration body according to claim 1.

14. The speaker device according to claim 13, wherein the support member for the speaker vibrating body is an edge.

15. The speaker device according to claim 13, wherein the support member for the speaker vibrating body is a damper.

16. The speaker device according to claim 14, comprising:
a speaker frame, the speaker vibrating body supported by the speaker frame, and a magnetic circuit, wherein
the speaker vibrating body includes a diaphragm, a voice coil, and a voice coil bobbin, and the magnetic circuit includes a yoke and a magnet.
